(19) United States
(12) Patent Application Publication
(10) Pub. No.: US 2004/0060712 A1
(43) Pub. Date: Apr. 1, 2004

(54) Multipurpose heavy-construction machine of the loader shovel type

(75) Inventor: Georges Charles, Limas (FR)

Correspondence Address: HESLIN ROTHENBERG FARLEY & MESITI PC, 5 COLUMBIA CIRCLE, ALBANY, NY, 12203, US

(73) Assignee: Volvo Construction Equipment Holding Sweden AB, Eskilstuna (SE)

(21) Appl. No.: 10/666,882

(22) Filed: Sep. 19, 2003

Related U.S. Application Data
(63) Continuation of application No. PCT/FR02/00974, filed on Mar. 20, 2002.

(30) Foreign Application Priority Data
Mar. 29, 2001 (FR) 01.04278

(51) Int. Cl. A01B 41/06

(52) U.S. Cl. 172/2

(57) ABSTRACT

A multipurpose engineering construction machine of the loader/shovel type has a mobile chassis centrally mounting a driving and control station. The chassis supports a loader assembly at the front, and a shovel assembly at the rear. These assemblies are capable of being controlled independently of one another via a hydraulic circuit selectively feeding a number of directional control valves that can be actuated by a manipulator and that control hydraulic actuators operating components of each assembly. The direction control valves are grouped together as a single module mounted transversely on the chassis between the rear axle and a frame supporting the shovel assembly. Hydraulic fluid supply is provided via a variable-throughput pump supplying a priority valve associated with the module. Distribution of fluid to each directional control valve is performed with a compensation balance allowing the deliveries to be adjusted in stages.

### TECHNICAL FIELD

The present invention relates to the technical field of engineering construction machines and more particularly of earth moving machines able to operate with equal ease either as a loader or as a shovel; in the remainder of the description these machines will be termed “loader/shovel” machines.

### PRIOR ART

Many proposals have hitherto been made for producing multipurpose engineering construction machines.

Among these solutions, as is apparent in particular from FR 1 483 942 (corresponding to U.S. Pat. No. 3,484,005) and from EP 0 084 067, it has been proposed for machines to be produced which, in general, comprise a chassis supported by two axles, one provided with driven wheels and the other with steered wheels.

This chassis supports, in its central part, a driving and control station. At the front of the chassis there is mounted a loader assembly and at the rear there is mounted an excavator assembly.

In the types of machines proposed hitherto, each work tool has its own control means for supplying the hydraulic actuators that actuate the constituent elements of each work tool. Each control actuator can therefore be controlled selectively via a hydraulic directional control valve that can be actuated by a manipulator, which manipulator may either be a mechanical control using lever and linkage or a hydraulic control or an electrical control.

As far as the directional control valves controlling the loader assembly are concerned, there are at least two of these, one for controlling the parallel arms articulated to the chassis and which support the bucket and a second directional control valve controlling the orientation of the bucket with respect to the arms and to the chassis.

There may be an additional control acting on the configuration of the bucket, this control generally being known as a 4 in 1 control.

Such a control is used when use is made of a bucket consisting of two separate elements offset from one another. The machine can then perform various functions according to the relative position of the two portions of the bucket, these functions being:

in a first configuration, presenting the two edges of the bucket contiguously to form a bucket the opening of which faces more or less upward and forward, so as to perform a loader function;

in a second configuration, presenting the two parts of the bucket one above the other in a more or less vertical arrangement, to form a tool that acts as bulldozer blades; and

in a third configuration, presenting the two parts of the bucket in a roughly horizontal configuration so that they can be parted from one another gradually to perform a gripper function for gripping objects placed on the ground; and

in a fourth configuration, also positioning the two parts of the bucket in a roughly horizontal position so that they can be parted from one another to drop the materials that the bucket is transporting, so as to perform a dumper function.

This possibility therefore leads to the presence of an additional manipulator for moving the two constituent parts of the bucket, and which therefore acts on an additional directional control valve.

In this type of machine, the directional control valves for controlling the loader assembly are therefore grouped together on the chassis, more or less in the region of the driving controls.

As far as the shovel assembly is concerned, this being mounted at the rear of the chassis, the directional control valves for supplying the control actuators are grouped together into a separate module mounted at the rear of the chassis.

When the shovel assembly is in use, once the machine has been brought to a standstill, the operator can swivel his seat round in order, on the one hand, to lower the lateral stabilizers and, on the other hand, to actuate the means controlling the actuators for using the shovel.

Such a shovel assembly therefore entails, to operate it, the presence of at least six directional control valves, namely two for controlling the lateral stabilizers that the machine has, one for controlling the jib, one for controlling the articulated arm on said jib, one for controlling the bucket articulated to the end of the arm, and the last for controlling the rotation of the jib.

Such a design of hardware in which the directional control valves for the loader and shovel assemblies are separate from one another therefore entails a hydraulic circuit from the fluid supply pump and the return line leading to the fluid storage tank which is relatively complicated, and presents difficulty with accessing the directional control valves.

The first problem that the invention sets out to solve therefore concerns the production of a multipurpose machine comprising a hydraulic circuit for controlling the tools of the machine which is simplified in terms of its design, easy to install and very reliable to use.

Furthermore, such a circuit also makes it possible to have priority direction control.

Furthermore, the invention is also aimed at arranging the elemental directional control valves in such a way that the controls performing the excavator function are centralized, while those performing the loader function are distributed on either side of the aforementioned elements.

### SUMMARY OF THE INVENTION

In general, the invention therefore relates to a multipurpose engineering construction machine of the loader/shovel type comprising a moving chassis in the central part of which there is mounted a driving and control station, said chassis supporting, at the front, a loader assembly and, at the rear, a shovel assembly or excavator, which assemblies can be controlled independently of one another via a hydraulic circuit selectively feeding a number of directional control valves that can be actuated by a manipulator and that control the hydraulic actuators operating the constituent elements of each work tool, and it is characterized in that:

all the directional control valves supplying the tool control actuators are grouped together in the form of a single module mounted transversely on the chassis, this being between the rear axle and the frame supporting the shovel assembly;

the supply of hydraulic fluid is via a variable-throughput pump supplying a priority valve on the direction function, associated with the unit grouping the directional control valves together;

the distribution of fluid to each directional control valve is performed with a compensation balance allowing the deliveries to be adjusted in stages.

According to a preferred embodiment, the directional control valves supplying the actuators that the shovel assembly comprises are manually controlled (but could just as easily be hydraulically controlled) and the directional control valves of the actuators of the loader assembly are, for their part, hydraulically controlled. In such a case, the directional control valves of the loader assembly are arranged laterally with respect to those of the shovel assembly, thus making hydraulic connection with said loader assembly situated at the front of the machine easier.

### BRIEF DESCRIPTION OF THE DRAWINGS

The way in which the invention is achieved and the advantages ensuing therefrom will become better apparent from the description of the embodiment which follows, illustrated by the attached figures, in which:

FIG. 1 is an overall side view of a machine of the loader/shovel type;

FIG. 2 is a schematic view from above illustrating the way in which the chassis of such a machine is produced and the mounting of the directional control valves on this chassis;

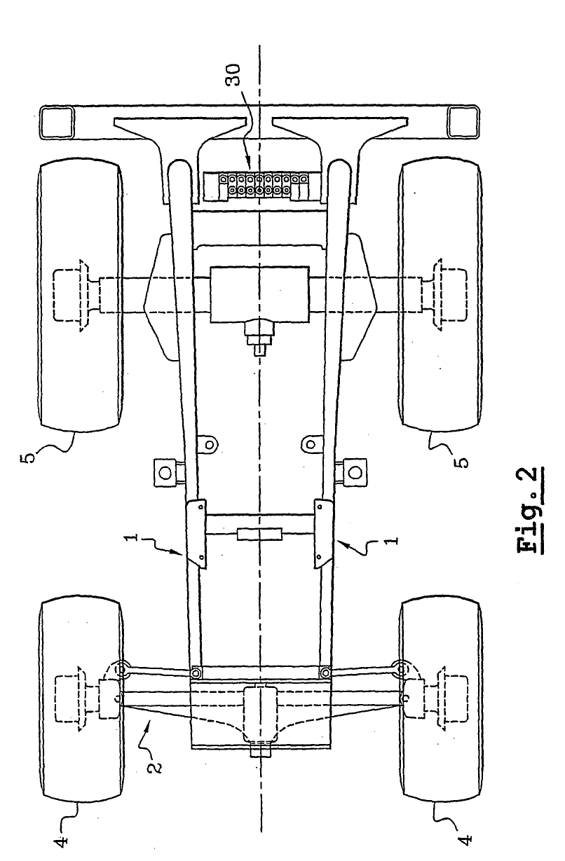

FIG. 3 is a detailed view of the embodiment of the unit comprising the elemental directional control valves and the way in which they are mounted on the chassis of the machine;

FIG. 4 is a simplified diagram of the hydraulic circuit feeding the directional control valves of a machine produced according to the invention.

### EMBODIMENT OF THE INVENTION

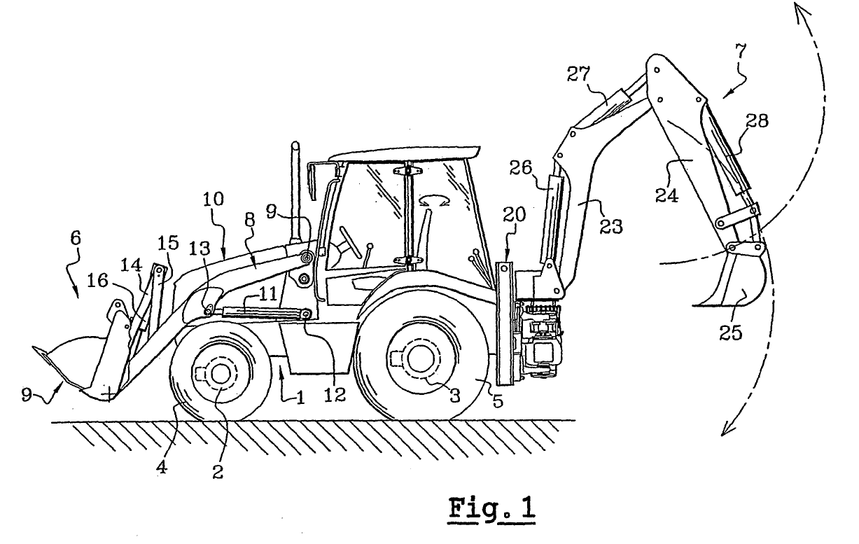

Referring to the attached FIG. 1, the invention therefore relates to an engineering construction machine of the loader/shovel type.

This machine therefore essentially comprises a chassis, denoted by the general reference (1), supported by two axles (2, 3), the front axle (2) being provided with steered and driven wheels (4) and the rear axle with large-diameter driven wheels (5).

Mounted on the chassis is a combustion engine which drives a gearbox with converter which are connected by a transmission to the two, front and rear, axle assemblies and the hydraulic circuit for controlling the work equipment also mounted on said chassis.

Said work equipment consists, on the one hand, of an assembly of the loader type denoted by the general reference (6), mounted at the front of said chassis and, on the other hand, of an assembly of the “shovel” or “excavator” type denoted by the general reference (7), for its part mounted at the rear of the chassis.

In general, the structure of such a machine is comparable with that covered by patent EP 0 084 067.

In the illustrated embodiment, the loader assembly (6) comprises two arms (8) articulated at (9) to the chassis and arranged one on each side of the hood (10). These arms (8) can be moved under the action of two arm actuators (11) also situated laterally on the chassis at (12) and the rod of which acts on the intermediate part (13) of the lateral arms (8).

Mounted in a known way at the end of the lateral arms (8) is a bucket (9) associated with link rods (14, 15) forming a deformable parallelogram.

The bucket (9) can be inclined via an actuator (16). The bucket (9) may possibly consist of an assembly comprising two distinct elements offset from one another and allowing several configurations to be adopted allowing it, apart from the loading function, to perform the functions of a bulldozer blade, or of a gripper, or of a dumper.

The shovel assembly (7) for its part is mounted at the rear of the chassis on a rigid transverse frame (20) set back from the driven wheels (5). This shovel assembly is conventional and is essentially made up of a jib (23) associated with an arm (24) at the end of which a bucket (25) is mounted. The jib (23) receives a rotational movement about a vertical axis with respect to the chassis. Furthermore, the jib (23) is articulated with respect to the chassis, the arm (24) for its part being articulated with respect to the end of said jib (23) and the bucket (25) with respect to the end of the arm (24).

The position of the elements with respect to one another is controlled via actuators (26, 27, 28).

Furthermore, two lateral stabilizers, not depicted in the attached diagrams, are also mounted on the chassis.

The driving and control station of the machine is mounted on the central part of the chassis. This control station therefore comprises the conventional driving means and the manipulators, preferably of hydraulic type, for selecting the directional control valves that control the various actuators of the loader assembly.

This driving station is designed so that simply by swiveling the seat around, use can be made of the shovel assembly arranged at the rear.

In the concrete example given, the shovel assembly is controlled by six directional control valves that can be actuated using individual manual controls.

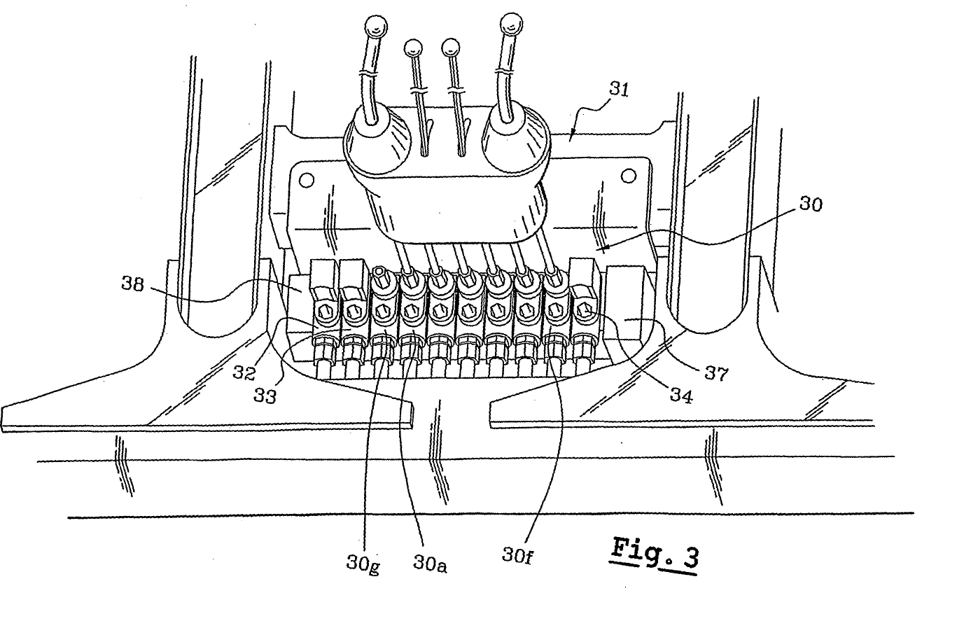

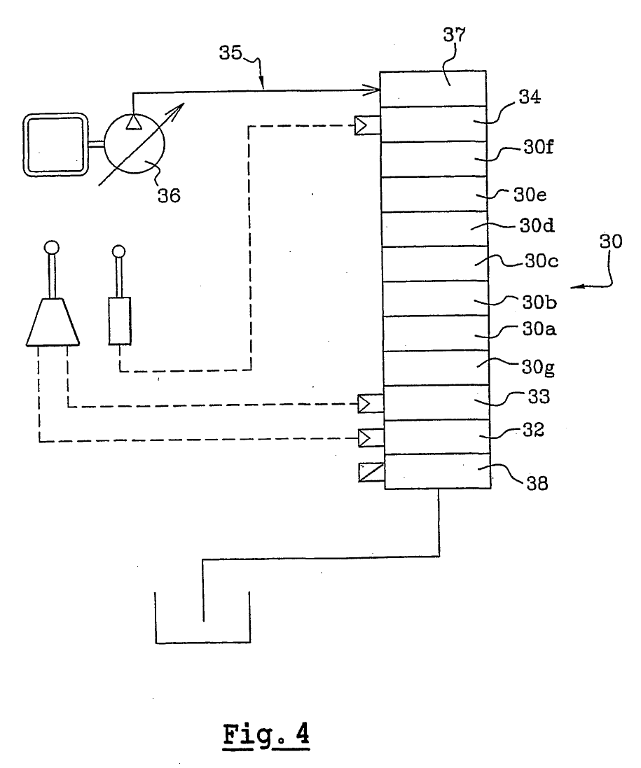

According to the invention, all the directional control valves supplying the control actuators both of the loader and of the shovel are grouped together in the form of a module (30) as depicted in FIGS. 3 and 4. This unit or module (30) is mounted on a transverse beam (31) secured to the two longitudinal members that make up the chassis, this being via damping assemblies able to absorb the stresses experienced by said chassis during the work operations.

In the concrete exemplary embodiment given, and which is illustrated in FIGS. 3 and 4, the directional control valve unit (30) comprises six mechanically controlled directional-control valves (30a to 30f) intended to provide the controls for the shovel which are situated at the rear of the machine. A seventh directional control valve (38g) is also provided as original equipment on the assumption that the machine can take additional optional accessories.

The directional control valves (32, 33, 34) intended to supply the actuators of the loader assembly are arranged laterally with respect to those of the shovel assembly thus making mechanical connection with the controls of the loader which are situated at the front of the machine easier.

By virtue of such a design in which the directional control valves for controlling the actuators of the two working assemblies are grouped together, it is then possible to have a hydraulic circuit that has just one connection (35) to a variable-throughput hydraulic pump (36).

This circuit (35) is associated with a priority valve (37) on the direction function.

Furthermore, each of the directional control valves is supplied with a shared delivery.

In addition, an electrically controlled directional control valve (38) for the actuators that immobilize the shovel is also associated with the directional control valve unit (30).

Finally, while in the example given the directional control valve control is hybrid, namely mechanical and hydraulic, these controls could just as easily be entirely hydraulic.

Compared with the earlier solutions in which the directional control valves of the loader assembly and those of the shovel assembly are separate, the solution according to the invention has numerous advantages among which mention may be made of ease of mounting and of maintenance, given the fact that all the functions are incorporated into a single unit.

1. A multipurpose engineering construction machine of the loader/shovel type comprising a moving chassis in the central part of which there is mounted a driving and control station, said chassis supporting, at the front, a loader assembly and, at the rear, a shovel assembly or excavator, which assemblies can be controlled independently of one another via a hydraulic circuit selectively feeding a number of directional control valves that can be actuated by a manipulator and that control the hydraulic actuators operating the constituent elements of each work tool, characterized in that:
all the directional control valves supplying the tool control actuators are grouped together in the form of a single module (30) mounted transversely on the chassis, this being between the rear axle and the frame supporting the shovel assembly;
the supply of hydraulic fluid is via a variable-throughput pump (36) supplying a priority valve (37) on the direction function, associated with the unit (30) grouping the directional control valves together;
the distribution of fluid to each directional control valve is performed with a compensation balance allowing the deliveries to be adjusted in stages.

2. The engineering construction machine as claimed in claim 1, characterized in that the directional control valves supplying the actuators that the shovel assembly (7) comprises are manually or hydraulically controlled and the directional control valves of the actuators of the loader assembly (6) are hydraulically controlled.

3. The engineering construction machine as claimed in one of claims 1 and 2, characterized in that the directional control valves (32, 33, 34) of the loader assembly are arranged laterally with respect to those of the shovel assembly.
